(19) United States
(12) Patent Application Publication
(10) Pub. No.: US 2018/0349487 A1
(43) Pub. Date: Dec. 6, 2018

(54) FILE DISPOSITION REVIEW SYSTEM

(71) Applicant: MICROSOFT TECHNOLOGY LICENSING, LLC, Redmond, WA (US)

(72) Inventors: Nakul GARG, Sammamish, WA (US); Kannan DHANASEKARAN, Redmond, WA (US); Lin HUANG, Redmond, WA (US); Sanjay RAMASWAMY, Redmond, WA (US); Churli SU, Bellevue, WA (US); Mu JIANG, Redmond, WA (US); Ning XU, Seattle, WA (US); Liming CHEN, Redmond, WA (US); Mingquan XUE, Redmond, WA (US); Binfeng YUAN, Seattle, WA (US); Subhayan Sen, Lynnwood, WA (US)

(21) Appl. No.: 15/610,561

(22) Filed: May 31, 2017

(51) Int. Cl. G06F 17/30; G06Q 40/08; G06Q 10/10

(52) U.S. Cl. CPC G06F 17/30707; G06Q 40/08; G06Q 10/06; G06F 17/30607; G06Q 10/10

(57) ABSTRACT

A file disposition review system analyzes multiple productivity platforms to generate an upcoming disposition report identifying data files that have reached a disposition review age associated with a file management label. A cross-platform manual review (CPMR) portal enables concurrent examination of file property data for data files identified in the upcoming disposition report. The CPMR portal further enables the disposition manager to simultaneously examine file property data corresponding to the data files identified in the upcoming disposition report and to issue disposition instructions. Exemplary disposition instructions may cause the multiple productivity platforms to permanently delete the identified data files without their underlying file content ever being transferred and/or copied from the particular productivity platforms that individual ones of the identified data files correspond to.

### BACKGROUND

Organizations develop data retention policies to establish procedures for retaining information for operational or regulatory compliance purposes. For instance, an organization may develop a data retention policy to abide by government regulations that require certain financial documents to be retained for at least a predefined minimum retention period. Some conventional file retention management solutions manage files that are labeled as records by using dedicated file management infrastructures that are separate from a platform that originally created the files. These conventional techniques have drawbacks such as unwanted file duplication and system complexity. For example, if a user labels an email file that is stored in the user's inbox, convention file retention management systems generate a copy of this email file and store the copy in a dedicated file management infrastructure.

Conventional file retention management solutions also lack an ability to reach across multiple productivity platforms, within a single consolidated experience, to provide for manual review and disposal of files stored across these multiple productivity platforms. Accordingly, for businesses utilizing numerous different productivity platforms, successfully implementing a uniform data retention policy across the entire organization may currently require independent monitoring of multiple different productivity platforms to identify files that have reached or are approaching their file retention age.

It is with respect to these considerations and others that the disclosure made herein is presented.

### SUMMARY

The disclosed system addresses the problems described above. Specifically, the file disposition review system described herein provides benefits over conventional file retention management solutions by, for example, analyzing multiple productivity platforms to identify a plurality of data files contained throughout a number of productivity platforms that have reached a disposition review age corresponding to a file management label and by further provisioning a disposition manager account with access to file property data that corresponds to the plurality of data files. In some embodiments, configurations disclosed herein cause a computing device to display a cross-platform manual review (CPMR) portal that indicates file properties for individual data files that have reached a disposition review age and also includes user interface elements (UIEs) usable to instruct the productivity platforms how to treat the individual data files. For example, the UIEs may be deployed to cause the productivity platforms to permanently delete a first subset of the plurality of data files and to reclassify a second subset with a superseding file management label.

Generally described, the techniques disclosed herein enable the system to generate a file management label that is based on retention parameters defining one or both of a file retention age and a disposition manager account. In various examples, the retention parameters may be received from a retention policy administrator account that is provisioned with access permissions that permit a retention policy administrator to define aspects of a unified retention policy that is deployed across multiple productivity platforms. After generating the file management label, the system may publish the file management label to the multiple productivity platforms to enable data files that are created by the productivity platforms to be tagged with the file management label. In some embodiments, a user (e.g., an information worker) may manually tag individual data files with the file management label to classify the individual data files with respect to the unified retention policy. Alternatively or additionally, the system (and/or individual productivity platforms thereof) may automatically tag individual data files with the file management label based on one or more attributes of the individual files. For example, the file management label may be automatically applied to individual data files that have one or more predefined characteristics that can be identified by the system and/or an individual productivity platform. As a more specific but nonlimiting example, a file labeling engine may be deployed to automatically tag individual files with a particular file management label based on one or more keywords contained within the file (e.g., files containing at least one of the terms “Tax*”, or “Form 1099*”, etc. will be automatically tagged with a “Tax Record” label.)

The system may also be configured to generate an upcoming dispositions report that identifies data files that have been tagged with the file management label and that have further reached a disposition review age associated with the particular file management label. In various examples, the disposition review age may be defined by the file management label. For example, the file management label may define the disposition review age as a predetermined time period that is to be measured from a date that individual data files were created and/or last modified. In some examples, the disposition review age may be defined based on filtering parameters generated via the UIEs that are included within the CPMR portal. For example, a disposition manager may manipulate the UIEs to associate and/or dynamically modify the disposition review age with respect to the file management label. In various examples, the data files identified within the upcoming-dispositions report may be dispersed across multiple different productivity platforms. For example, the upcoming-dispositions report may indicate emails that have reached the disposition review age and that reside on a communication platform as well as other data file types that have reached the disposition review age and that reside on a file hosting platform.

Based on the upcoming-dispositions report, the system may cause a computing device to display, within the CPMR portal, UIEs that enable generation of input data indicating one or more retention actions that are to be performed by the productivity platforms with respect to one or more individual data files identified within the upcoming-dispositions report. In various examples, the input data may include disposition confirmations corresponding to individual data files (e.g., confirmations that the individual data files should be permanently deleted upon reaching a corresponding retention age), extended disposition review ages corresponding to individual data files (e.g., a new disposition review age and/or an amount of time to extend an existing disposition review age), or a superseding label to tag the individual data file for reclassification with respect to the unified retention policy.

In various examples, the system may further cause the CPMR portal to indicate file properties corresponding to individual files that are tagged with the file management label and that have reached the disposition review age. Exemplary file properties for an individual data file include, but are not limited to: an owner of the individual data file (e.g., a user account that the individual data file is stored in association with and/or a user account that the individual data file was generated with respect to); a file location that indicates a particular productivity platform that the individual data file corresponds to and/or a specific folder within a directory structure of that productivity platform; a subject and/or title of the individual data file; a record type indicating how the individual data file is classified with respect to the retention policy; how the individual data file was tagged with the label (e.g., whether the individual file was tagged automatically and/or by whom the individual data file was manually tagged); a date that the individual data file was tagged and/or created and/or last modified and/or is set to expire; and any other file property that is suitable for consideration with respect to a retention policy.

In some examples, the filter parameters generated via the UIEs that are included within the CPMR portal may define the disposition review age by defining an expiration window for the upcoming-disposition report. For example, a user may input filter parameters that define an expiration window ranging from Jun. 15, 2017 through Jul. 15, 2017 to cause the CPMR portal to identify data files that are set to expire within this specified expiration window. In various examples, the expiration window may be at least partially in the future such that at least some dates within the expiration window have yet to be reached. In such examples, the CPMR portal may display file properties of and receive input data for data files that have not yet expired (e.g., have yet to reach a file retention age). Accordingly, the disposition confirmations may be generated in association with individual data files that have yet to reach a corresponding file retention age. Then, these individual data files may be automatically disposed of by their corresponding productivity platforms when they reach their file retention age without further review.

Based on the input data generated via the one or more UIEs, the system may also be configured to cause individual productivity platforms to execute disposition instructions with respect to individual data files. For example, the system may transmit a first disposition instruction to cause a communication platform to permanently delete a plurality of email files that are tagged with the specified file management label and that have reached the specified file retention age, and a second disposition instruction to cause a file hosting platform to permanently delete a plurality of other files that are tagged with the specified file management label and that have reached the specified file retention age. In various examples, the system may prevent individual productivity platforms from deleting individual data files (even after the individual data files reach a specified retention age) until a corresponding disposition confirmation is received. For example, suppose that a particular data file has been tagged with a file management label that defines a retention age of seven years. Under these circumstances, even if the particular data file has surpassed seven years of age, the system may forcibly retain the particular data file (e.g., prevent individual productivity platforms from deleting the particular data file) until a disposition manager confirms that the underlying file content of the particular data file should be permanently deleted.

The system may further be configured to generate a historical-dispositions report that includes file property data of individual data files that have been purged (e.g., permanently deleted) from storage corresponding to one or more productivity platforms. For example, upon the underlying file content of the particular file being permanently deleted, the system may retain at least some file property data of the particular file. The file property data included within the historical-disposition report may include any of the file property data discussed with respect to the upcoming-disposition report. Additionally or alternatively, the file property data included within the historical-disposition report may indicate a disposal date corresponding to particular data files (e.g., a date at which the underlying file content of the particular data file was permanently deleted.) In various examples, the historical-disposition report may be exported to a local device and/or transmitted to a third-party to demonstrate adherence to a particular retention policy. For example, an organization may transmit a historical-disposition report to a governmental agency as evidence that the organization has regularly retained particular classes of data files (e.g., tax related documents) for at least a legally prescribed minimum time period.

Configurations disclosed herein provide a marked improvement to the technological field of records management for at least the reason that conventional file retention management systems fail to enable the disposition manager to review properties of expired and/or soon to be expired data files that exist across multiple productivity platforms. In particular, conventional file retention management systems generally copy the underlying file content of expired and/or soon to be expired data files to a dedicated file management infrastructure that exists separately from the file(s)′ corresponding productivity platform(s). Accordingly, configurations disclosed herein improve upon conventional file retention management systems by mitigating the necessity of duplicating underlying file content data to file management systems that exist apart from the productivity platforms.

It should be appreciated that, although described in relation to a system, the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings. This Summary is provided to introduce a selection of concepts in a simplified form that are further described below in the Detailed Description.

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates a data flow scenario of a system that provisions a disposition manager with access to a single cross-platform manual review (CPMR) portal to enable concurrent examination of file property data for data files that reside across multiple productivity platforms and that have reached a specified disposition review age.

FIG. 2 illustrates aspects of a user interface (UI) corresponding to a retention policy management portal (RPMP) that can be displayed to enable a retention policy administrator to define retention parameters corresponding to a file management label that is associated with a disposition review age as described herein. Similar to other interfaces described herein, this example UI can be displayed on a variety of device types, such as a desktop computer, mobile device or a combination of devices.

FIG. 3A illustrates aspects of a UI corresponding to the CPMR portal that can be displayed to communicate aspects of the upcoming-disposition report that indicates one or more individual data files that have reached the disposition review age.

FIG. 3B illustrates aspects of another UI that corresponds to the CPMR portal and that includes one or more user interface elements (UIEs) that enable the disposition manager to generate input data that defines one or more retention actions to be performed in association with one or more individual data files.

FIG. 3C illustrates aspects of another UI that corresponds to the CPMR portal and that includes one or UIEs that enable the disposition manager to define one or more bulk retention actions to be performed in association with a plurality of selected individual data files.

FIG. 4 illustrates aspects of a UI corresponding to the CPMR portal that can be displayed to communicate aspects of a historical-dispositions report that indicates file property data of individual data files that have been purged from storage corresponding to one or more productivity platforms.

FIG. 5 is a flow diagram of an illustrative process to generate data retention reports associated with disposition of data files that are tagged with a file management label.

FIG. 6 shows additional details of an example computer architecture for a computer capable of executing a retention policy management service, a CPMR portal, productivity platform, and/or any program components thereof as described herein.

### DETAILED DESCRIPTION

The following Detailed Description describes a file disposition review system that provides benefits over conventional file retention management systems by, for example, analyzing multiple productivity platforms to identify data files that have reached a disposition review age that is associated with a file management label and by further provisioning a disposition manager account with access to file property data that corresponds to these data files. Generally described, configurations disclosed herein enable a system to provision access to a single cross-platform manual review (CPMR) portal that enables concurrent examination of file property data for data files that have reached a specified disposition review age across the multiple productivity platforms. In various examples, the CPMR portal enables a disposition manager to examine file property data corresponding to data files that have expired and/or are soon to expire (e.g., files having reached a disposition review age but not yet having reached a file retention age). The CPMR portal further enables the disposition manager to issue instructions directly to multiple productivity platforms regarding how to treat the identified data files with respect to a retention policy (e.g., whether to permanently delete the files and/or whether to perform some other retention action).

As described above, using a single CPMR portal to manually review file property data corresponding to data files that are stored across multiple productivity platforms provides benefits over conventional file management systems for at least the reason that underlying file content of the data files need not be copied to any dedicated file management infrastructures. To illustrate, suppose that a label has been used to tag a particular class of files such as, for example, tax related files that exist across multiple productivity platforms (e.g., tax related emails residing on a computer communication platform as well as tax related documents and/or spreadsheets residing on a file hosting platform). Under these circumstances, the techniques disclosed herein enable a disposition manager to simultaneously examine file property data corresponding to these tax related files from the single CPMR portal and, ultimately, to issue disposition instructions causing the multiple productivity platforms to permanently delete the tax related files without ever having to transfer file content from and/or copy their underlying file content to their corresponding particular productivity platforms.

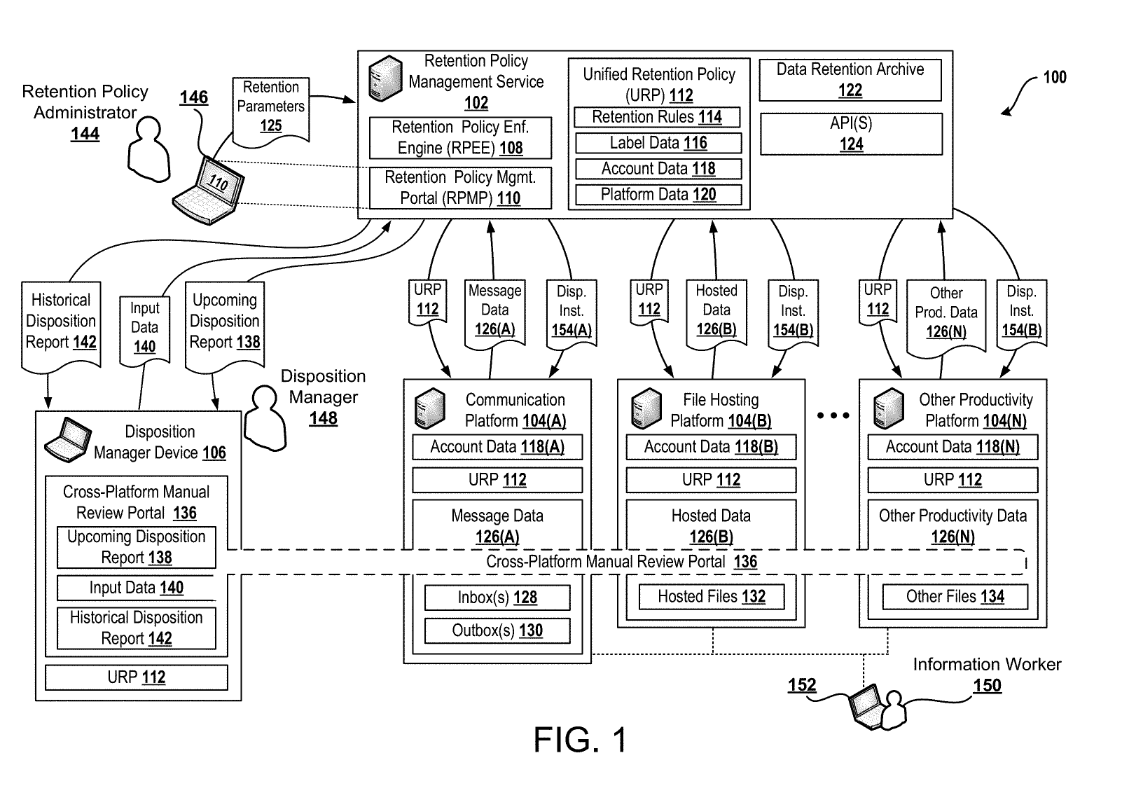

Various examples, implementations, scenarios, and aspects are described below with reference to FIGS. 1 through 6. It can be appreciated that operations and/or functionalities may be described according to a logical flow of data between various components. The order in which these operations and/or functionalities are described and/or illustrated herein is not intended to be construed as a limitation. Rather, any number of the operations and/or functionalities described with respect to any figure may be combined in any order and/or in parallel in accordance with the present disclosure. Other processes and/or operations and/or functionalities described throughout this disclosure shall be interpreted accordingly.

As used herein, the term “productivity platform” refers to local and/or web-based software that is dedicated to producing, modifying, and/or accessing information such as, for example, email, live chat sessions, word processing documents, presentations, workbooks (a.k.a. “worksheets”), and/or Internet/Intranet share sites. Exemplary productivity platforms include, but are not limited to, communication platforms (e.g. email services, instant messaging services, on-line video chat services, etc.) and file hosting platforms (e.g. personal cloud based storage, online file sharing services). Furthermore, in some implementations, the individual productivity platforms may be components of a productivity suite (e.g. GOOGLE G-SUITE, ZOHO OFFICE SUITE, or MICROSOFT OFFICE 365) such that a single set of user credentials may be issued to provision a user with access to a plurality of different productivity platforms.

As used herein, the term “retention policy administrator” refers generally to an individual within an organization that is responsible, in whole or in part, for generating and/or reviewing and/or modifying an organization's retention policy such as, for example, the unified retention policy described herein.

As used herein, the term “information worker” refers generally to those individuals within an organization that are responsible for generating, reviewing, signing-off on, or otherwise interacting with files that are affected by the unified retention policy.

As used herein, the term “disposition manager” refers generally to an individual within an organization that is responsible, in whole or in part, for reviewing upcoming-disposition reports that indicate at least some file properties of individual data files that have expired and/or are soon to expire (e.g., have reached or will reach a corresponding file retention age) and are further responsible for generating input data to instruct individual productivity platforms how to treat the individual data files. For example, as will be described in more detail elsewhere herein, a disposition manager may receive a notification associated with an upcoming-disposition report that indicates a plurality of data files that will reach their corresponding file retention age(s) within the next one month. Upon reviewing the upcoming-disposition report, the disposition manager may generate instructions corresponding to individual data files to cause the individual productivity platforms to perform one or more retention actions. Exemplary retention actions include, but are not limited to, permanently deleting an individual data file, copying an individual data file to a data retention archive, assigning an individual data file with a new disposition review age, and/or assigning an individual data file with a superseding label for reclassification with respect to the unified retention policy.

As used herein, a “unified retention policy” refers generally to a set of data retention rules that are configured to be deployed across multiple productivity platforms. An exemplary unified retention policy may include one or more data retention rules that are configured according to a rule development scheme that is shared across various platforms of a productivity suite. As a specific example, a productivity suite may include multiple productivity platforms (e.g. a communication platform providing email and/or chat capabilities, a file hosting platform providing cloud file storage capabilities, etc.) as well as a retention policy management portal to enable a user to develop and manage data retention rules that are “unified” in the sense that individual data retention rules can be selectively deployed across multiple productivity platforms. As used herein, the term “prescribe” may refer generally to authoritatively establishing and/or defining policies and/or assigning policies to platforms, users, and/or groups of users. As used herein, the term “deploy” may refer generally to enforcing or otherwise bringing into action.

Turning now to FIG. 1, an example data flow scenario is illustrated with respect to a system 100 that provisions a disposition manager with access to a single CPMR portal to enable concurrent examination of file property data for data files that reside across multiple productivity platforms and that have reached a disposition review age. As illustrated, the system 100 may include a retention policy management service 102 that may transmit a unified retention policy (URP) to multiple productivity platforms 104. The retention policy management service 102 may generate and/or modify the URP based on retention parameters that are received from a retention policy administrator. As illustrated by the dashed line connecting the multiple productivity platforms 104, an information worker 150 may access individual ones of the multiple productivity platforms via a user device 152. The system 100 may further include a disposition manager device 106 through which the disposition manager may access the CPMR portal to review file property data for data files that reside across the multiple productivity platforms 104 and that have reached their corresponding disposition review age(s).

As illustrated in FIG. 1, exemplary productivity platforms may include, but are not limited to, a communication platform 104(A), a file hosting platform 104(B), and any other type of productivity platform 104(N). In some instances, the communication platform 104(A) may be configured to enable a user to send and receive communications such as, for example, emails and/or instant messages. Exemplary communication platforms include, but are not limited to, MICROSOFT OUTLOOK and/or GOOGLE GMAIL. In some instances, the file hosting platform 104(B) may be configured to enable a user to open, view, edit, create, save, copy, or otherwise manipulate files such as, for example, text documents, spreadsheet documents, and/or presentation documents. Exemplary file hosting platforms include, but are not limited to, MICROSOFT WORD ONLINE, MICROSOFT EXCEL ONLINE, MICROSOFT POWERPOINT ONLINE, MICROSOFT ONEDRIVE, GOOGLE DOCS, GOOGLE SHEETS, GOOGLE SLIDES, and/or GOOGLE DRIVE.

The retention policy management service 102 may include a retention policy enforcement engine (RPEE) 108 that is configured to enforce the URP 112 across one or more of the productivity platforms 104. The URP 112 may include, but is not limited to, one or more data retention rules 114 that define various actions to be performed with respect to files that satisfy one or more predefined conditions. For example, the URP 112 may expressly prescribe one or both of a disposition review age and a file retention age for files that are determined to be tax related (e.g., based on a label or otherwise).

The URP 112 may further include label data 116 defining one or more file management labels that individual data files that reside on one or more of the productivity platforms 104 may be tagged with for classification purposes. For example, an information worker 150 may review email messages within an inbox and/or outbox at the communication platform 104(A) and manually apply a “Tax Record” label to an individual email message to classify the individual email message with respect to the URP 112 and/or to cause the RPEE 108 to prescribe one or more of the data retention rules 114 to the individual email message. Then, the system 100 may generate upcoming disposition reports that identify individual data files that are tagged with a particular file management label and that have reached a disposition review age associated with the particular file management label. The CPMR portal may enable a disposition manager to view file properties of the individual data files identified by the upcoming disposition reports and, ultimately, to instruct individual productivity platforms 104 to perform particular file retention actions with respect to the individual data files. For example, via the CPMR portal, the disposition manager may select a first subset of the data files that are to be permanently disposed of and a second subset of the data files that are to have their disposition review age extended and/or are to be reclassified with a different classification label (also referred to herein as “label”).

The URP 112 may further include account data 118 that is associated with productivity platform user accounts assigned to individual information workers and/or groups of information workers, individual disposition managers and/or groups of disposition managers, and/or individual retention policy administrators and/or groups of retention policy administrators. For example, the organization may provision information workers with access to one or more of the productivity platforms 104 by assigning the information workers with unique credentials (e.g., a username and password combination) that can be used to sign-into associated productivity platform user accounts.

The unified retention policy 112 may further include productivity platform data 120 that is associated with individual ones of the productivity platforms 104. For example, the productivity platform data 120 may indicate system parameters corresponding to the communication platform 104(A) as well as system parameters corresponding to the file hosting platform 104(B). Exemplary system parameters include, but are not limited to, one or more file types that are associated with an individual productivity platform (e.g. a type of email file that the communication platform 104(A) is configured to send or receive), instructions that enable the system to navigate an organizational scheme of the productivity platforms, or instructions that enable the system to analyze different data file types that are associated with various productivity platforms.

The retention policy management service 102 may be configured to expose a retention policy management portal (RPMP) 110 to enable a retention policy administrator to indicate retention parameters 125 that define one or more aspects of the URP 112. For example, the retention parameters 125 may prescribe the URP 112 to individual ones of the productivity platforms 104 and/or individual user accounts thereof. In accordance with the techniques described herein, the retention parameters 125 may indicate a retention age for a particular file management label and a disposition manager that is assigned to review data files (or file properties thereof) that are tagged with the particular file management label once those data files reach a corresponding disposition review age. In some implementations, the particular file management label may define the disposition review age as well as a file retention age. For example, a particular file management label may define a file retention age of seven years and a disposition review age of six years and eleven months to cause the system 100 to prompt the disposition manager to review, and ultimately generate disposition instructions for, individual data files during the month prior to the individual data files reaching their file retention age.

The retention policy management service 102 may further include a data retention archive 122 that is configured to permanently store data files that have been selected for archiving in accordance with techniques described herein. For example, while reviewing individual data files that have reached their corresponding disposition review ages, the disposition manager may determine that a particular data file that is soon to expire (e.g., a file that is nearing its retention age) is of historical value and should be permanently archived. Accordingly, the disposition manager may instruct a productivity platform to transfer a copy of the particular data file to the retention policy management service 102 to be stored within the data retention archive 122.

The retention policy management service 102 may further include one or more application programming interfaces (APIs) 124 that expose an interface through which the retention policy management service 102 can send data to and/or receive data from the productivity platforms 104 and/or the disposition manager device 106 and/or a retention policy administrator device 146. Through the use of this data interface and other interfaces, the devices and services described herein can communicate and process data in such a manner as to enable the functionality and/or operations disclosed herein.

As illustrated, the productivity platforms may include corresponding instances of the account data 118. For example, the account data 118 may be comprised of account data 118(A) that corresponds to the communication platform 104(A), account data 118(B) that corresponds to the file hosting platform 104(B), and so on. Exemplary account data includes, but is not limited to, user credentials associated with the information worker 150 and/or account settings corresponding to a user account of the information worker. In some implementations, the account data 118(A) and the account data 118(B) may share similar user credentials data while having at least partially divergent account settings data. For example, the same user credentials may provision the information worker with access to each of the communication platform 104(A) and the file hosting platform 104(B) but the information worker 150 may have customized account settings with respect to one or both of the communication platform 104(A) and the file hosting platform 104(B).

The productivity platforms 104 may further include productivity data 126 that includes a plurality of files that are distributed across the productivity platforms 104 and which are subject to one or more retention rules 114 of the URP 112. For example, the communication platform 104(A) may include message data 126(A) associated with an email or other type of communication account whereas the file hosting platform 104(B) may include hosted data 126(B) corresponding to a cloud storage drive. For purposes of the present discussion, assume that the communication platform 104(A) includes message data 126(A) corresponding to one or more email inboxes 128 and/or one or more email outboxes 130. Further assume that the file hosting platform 104(B) includes hosted data 126(B) corresponding to one or more hosted files 132 which may include one or more synced files (e.g. files that are synchronized between the user device 152 and a productivity platform 104), and that the other productivity platform 104(N) includes other productivity data 126(N) including one or more files 134 that are also potentially subject to the URP 112.

The disposition manager device 106 enables a disposition manager 148 to access the CPMR portal 136 to view properties of data files that have reached a disposition review age and, ultimately, to instruct individual ones of the productivity platforms 104 to perform one or more retention actions with respect to the data files. For example, the disposition manager 148 may select a first subset of the data files to be permanently disposed of and a second subset of the data files to have their disposition review age extended and/or to be reclassified with a different file management label. In various examples, the CPMR portal 136 may cause a display (e.g., an LCD display, or other type of display monitor) of the disposition manager device 106 to render aspects of an upcoming disposition report 138 such as, for example, file property data for individual data files that have expired and/or are soon to expire based on a file retention age that is prescribed by a file management label that the individual data files have been tagged with.

The CPMR portal 136 may further include one or more user interface elements to enable the disposition manager to generate input data 140 indicating disposition instructions (i.e., instructions to perform one or more retention actions with respect to one or more individual data files) for individual productivity platforms 104. For example, the input data 140 may include a disposition confirmation to instruct an individual productivity platform to permanently delete a data file once that data file reaches its retention age (or if the particular file has already reached its retention age when the disposition confirmation is received to immediately delete the particular data file).

The CPMR portal 136 may further cause the display of the disposition manager device 106 to render aspects of a historical disposition report 142 that indicates file properties corresponding to individual data files for which the underlying file content has been permanently deleted from storage devices and/or storage allocations corresponding to the productivity platform(s) 104. The disposition manager device 106 may also include an instance of the URP 112 to enable the disposition manager 148 to reference one or more of the retention rules 114, the label data 116, the account data 118, and/or the platform data 120 while reviewing file property data of the data files via the CPMR portal 136.

With respect to the example dataflow scenario of FIG. 1, the retention policy management service 102 is shown to obtain retention parameters 125 that are generated by a retention policy administrator 144 via a retention policy administrator device 146. In various examples, the retention parameters 125 may define for a particular file management label one or both of a file retention age and a disposition manager account (i.e., a user account corresponding to the disposition manager 148). As used herein, a file retention age may define a minimum period of time during which the URP 112 prescribes that individual data files be forcibly retained (e.g., a time period during which requests to delete individual data files are denied). In various implementations, the file retention age may be measured from at least one of a date that an individual data file was created, a date that an individual data file was last modified, a date that an individual data file was tagged with a file management label, etc. The RPEE 108 may prevent deletion of individual data files until they reach their corresponding file retention age. The RPEE 108 may further prevent deletion of individual data files until the disposition manager 148 has generated input data 140, via the CPMR portal 136, that instructs the individual productivity platforms 104 to permanently delete the individual data files. That is, the RPEE 108 may prevent deletion of a particular data file until a disposition confirmation has been generated in association with the particular data file. Accordingly, in implementations in which permanent deletion of an individual data file is contingent upon receiving a corresponding disposition confirmation, the file retention age may define an earliest age at which the individual data file may be deleted from system storage if, and only if, a corresponding disposition confirmation is received in association with the individual data file.

Based on the retention parameters 125 that are received from the retention policy administrator device 146, the retention policy management service 102 may generate a file management label that defines a file retention age and/or notifies the disposition manager 148. The file management label may be stored within the URP 112 and, more specifically, the label data 116 thereof. Then, the retention policy management service 102 may publish the file management label by transmitting the URP 112 to one or more of the productivity platforms 104. In the context of the present disclosure, publishing a file management label to an individual productivity platform may refer to provisioning the information worker 150 with an ability to manually tag individual data files of that individual productivity platform with the file management label. Publishing a file management label to an individual productivity platform may also refer to provisioning the individual productivity platform itself with the ability to automatically tag individual data files with the file management label. For example, the file management label may be associated with one or more of the data retention rules 114 to enable the system 100 and/or individual productivity platforms 104 to automatically tag individual data files with the file management label based on one or more attributes of the individual files. For example, the file management label may be automatically applied to individual data files that have one or more predefined characteristics that can be identified by the system and/or an individual productivity platform. As a more specific but nonlimiting example, a file labeling engine (not shown) may be deployed to automatically tag individual files with a particular label based on the files including one or more keywords (e.g., files containing at least one of the terms “Tax*”, or “Form 1099*”, etc. may be automatically tagged with a “Tax Record” label.)

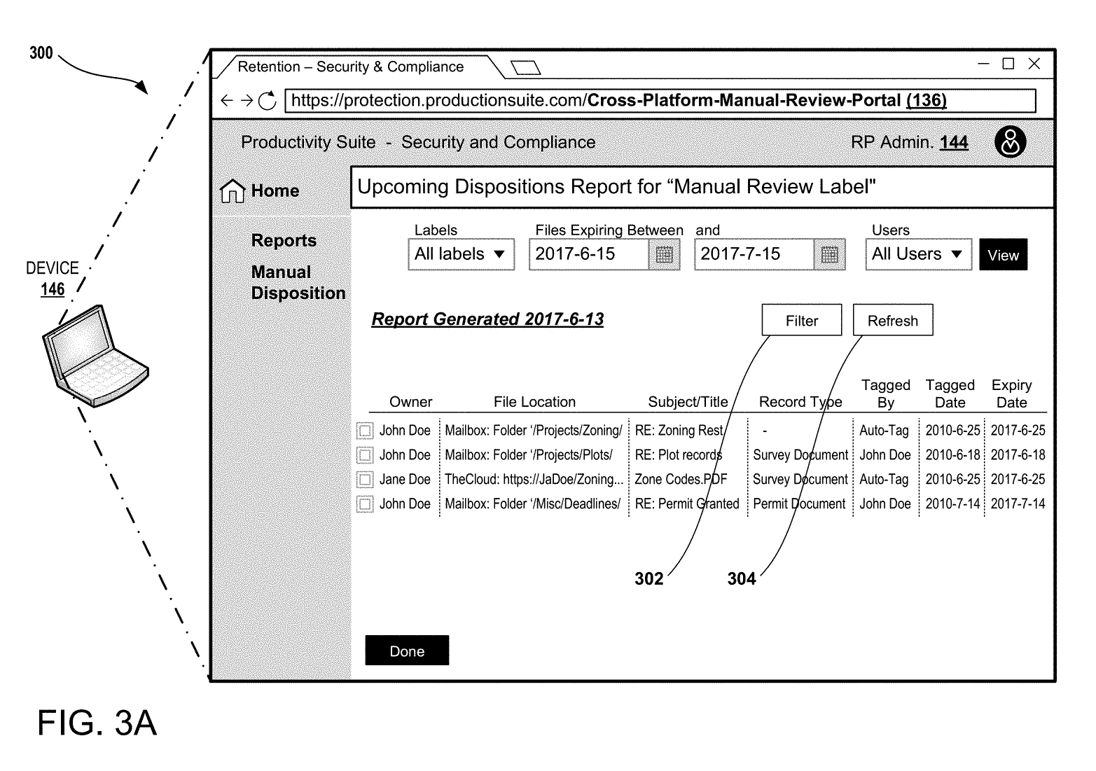

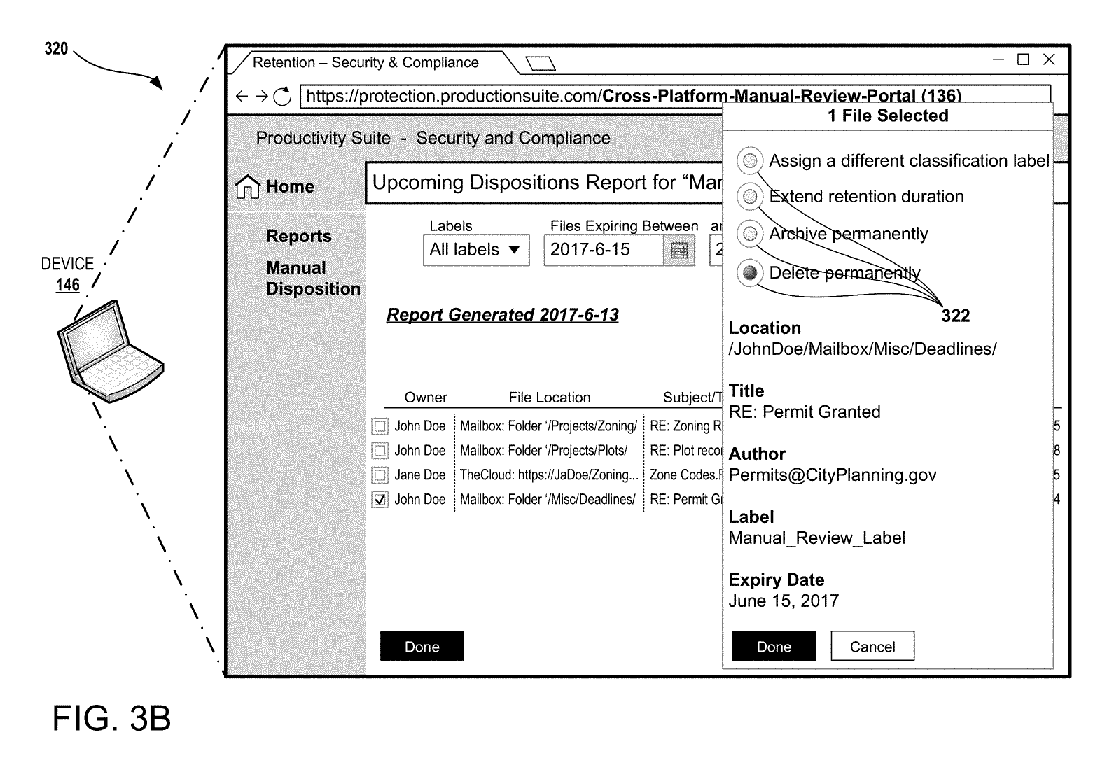

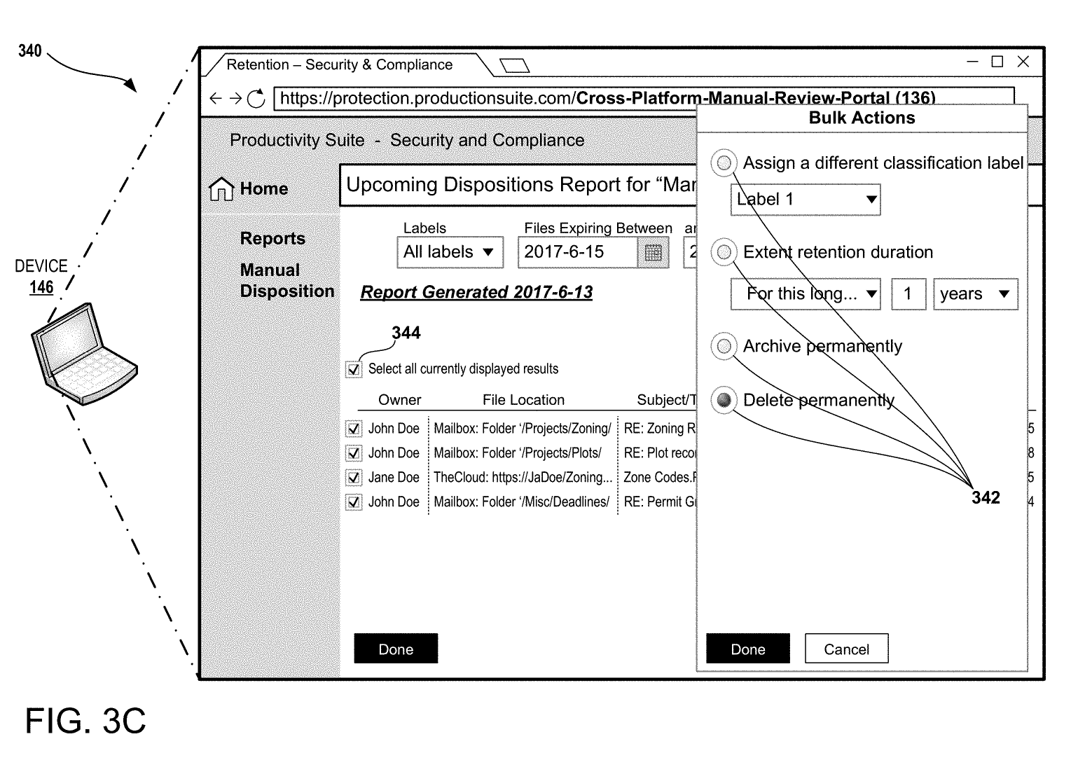

As further illustrated in FIG. 1, the productivity platforms 104 may transmit to the retention policy management service 102 at least a portion of the productivity data 126 wherein the transmitted portion corresponds to individual data files that have reached a disposition review age that is associated with the file management label. For example, the communication platform 104(A) may transmit a portion of the message data 126(A) that includes file property data associated with individual message files that have reached the disposition review age, the file hosting platform 104(B) may transmit a portion of the hosted data 126(B) that includes file property data associated with individual hosted files that have reached the disposition review age, etc. In some implementations, the disposition review age may be defined by the retention policy administrator 144 via the retention parameters 125. That is, the retention policy administrator 144 may define the age at which a particular data file that has been tagged with the file management label is to be reviewed by the disposition manager 148 to determine how to treat the particular data file in accordance with the URP 112 (e.g., to determine which retention actions, if any, are to be performed by the individual productivity platforms 104). In some implementations, the disposition review age may be defined by the disposition manager 148 via the CPMR portal 136. For example, as is described in more detail below with reference to FIG. 3A, in some implementations the disposition manager 148 may define an evaluation window to customize the upcoming disposition report 138 to show individual data files that have expired and/or are set to expire within the evaluation window.

Upon identifying the individual data files that have reached the disposition review age, the retention policy management service 102 may generate the upcoming disposition report 138 and, ultimately, transmit the upcoming disposition report 138 to the disposition manager device 106. In some examples, the upcoming position report 138 may include file properties for individual data files that have reached their corresponding disposition review age but have yet to reach their corresponding file retention age. In such examples, the disposition manager 148 may review file properties for individual data files that have not yet but will soon (e.g., within the next one day, within the next one week, within the next one month, within a predefined evaluation window, etc.) reach their corresponding file retention age. Then, the disposition manager 148 may instruct individual ones of the productivity platforms 104 how to treat these data files once they do finally reach their corresponding file retention age (or, for that matter, how to treat them immediately if they already have reached their corresponding file retention age). These such examples may be beneficial for an organization that strives to permanently delete data files as quickly as possible (e.g., immediately upon the files reaching their file retention age) but does not elect to automatically and uniformly delete all data files once they reach this file retention age (e.g., the organization elects to manually review file property data prior to permanently deleting data file content).

As illustrated, the retention policy management service 102 may then transmit the upcoming disposition report 138 to the disposition manager device 106. The disposition manager device 106 may then display various aspects of the upcoming disposition report 138 via the CPMR portal 136. For example, a display component of the disposition manager device 106 may visually render file properties of data files identified within the upcoming disposition report 138. In some implementations, the upcoming disposition report 138 may include file property data that indicates the file properties such that the CPMR portal 136 may display file property data upon receiving the upcoming disposition report 138 and without further communications with the retention policy management service 102 and/or individual productivity platforms 104. For example, the upcoming disposition report 138 may be generated in the form of a discrete data file (e.g., a “.cvc” file or any other suitable format) that includes the file property data. In some implementations, the CPMR portal 136 may be configured to communicate with one or more of the individual productivity platforms 104 and/or the retention policy management service 102 to obtain additional file property data (e.g., file property data that is omitted from the upcoming disposition report 138) corresponding to the data files identified within the upcoming disposition report 138. For example, under circumstances in which the disposition manager 148 elects to consider one or more additional file properties prior to instructing individual productivity platforms how to treat one or more individual data files, the CPMR portal 136 may enable the disposition manager 148 to request such additional file properties from the individual productivity platforms 104.

In some implementations, the portion of the productivity data 126 that is accessible by the disposition manager 148 is limited to file property data such that the disposition manager 148 is not permitted to access (e.g., view, copy, transmit, etc.) file content data associated with the individual data files that are identified within the upcoming disposition report 138. For example, the disposition manager 148 may be able to examine file properties corresponding to a particular data file such as, for example, who created the particular data file and how the data file is classified (e.g., which file management label has been tagged with the particular data file), and also an expiration date of the particular data file. However, the disposition manager 148 may be unable to examine the underlying file content (e.g., the body of an email message, the internal content of a report, or any other potentially sensitive information generated by the information worker 150). Stated alternatively, the file management label may be associated with access permissions that permit the disposition manager to examine file properties of tagged files while restricting the disposition manager from accessing the underlying contents (e.g., file content data) of the tagged files.

As used herein, the term “file property data” refers to data that indicates file properties associated with one or more individual data files. Exemplary file properties include, but are not limited to, a file type as indicated by a file extension (e.g., “.pdf,” or “.docx”), a location within a directory structure, a particular productivity platform that a particular file corresponds to, a date that a file was created, a date that a file was last modified, a date that a file was last accessed, a date that a file was tagged with the file management label, an expiry date of a file (e.g., a date that the file has reached or will reach its corresponding file retention age), etc. As used herein, the term “file content data” refers to data that indicates the underlying file content associated with one or more individual data files. That is, the core information that is contained within a data file that becomes accessible upon successfully opening the data file within an appropriate computing application. In some implementations, the portion of the productivity data 126 that is transmitted to the retention policy management service 102 and, ultimately, to the disposition manager device 106 includes file property data but omits file content data. Such implementations provide benefits over conventional file management systems for at least the reason that the present techniques may be implemented without generating and storing the file content data within any dedicated file management infrastructures, e.g., the file content data may be stored solely at its corresponding productivity platform. These techniques further reduce processing cycles and network bandwidth usage as substantially less bytes of data need be transmitted over public and/or private networks as compared to conventional file management systems.

The CPMR portal 136 may also include one or more user interface elements that enable the disposition manager 148 to generate input data 140 that specifies one or more retention actions for one or more individual data files. For example, based on an examination of the upcoming disposition report 138, the disposition manager 148 may generate input data 140 that specifically identifies a subset of data files identified within the upcoming disposition report 138 and further defines a specific retention action that is to be performed with respect to this subset of data files.

Then, the input data 140 may be transmitted to the retention policy management service 102. Based on the input data 140, the retention policy management service 102 may generate one or more disposition instructions 154 that indicate one or more specific retention actions that are to be performed with respect to one or more individual data files identified within the upcoming disposition report 138. The disposition instructions 154 may then be transmitted to the individual productivity platforms 104. In some implementations, the retention policy management service 102 may generate specific instances of the disposition instructions 154 that correspond to specific ones of the productivity platforms 104. For example, as illustrated, the retention policy management service 102 is shown to transmit a first disposition instruction 154(A) to the communication platform 104(A) and is further shown to transmit a second disposition instruction 154(B) to the file hosting platform 104(B), etc. Although the dataflow scenario of FIG. 1 shows the input data 140 being first transmitted to the retention policy management service 102 before ultimately being relayed to the individual productivity platforms 104 in the form of the disposition instructions 154, in some implementations the input data 140 may be transmitted directly to one or more individual productivity platforms 104 in the form of the disposition instructions 154.

Ultimately, individual productivity platforms 104 may execute corresponding disposition instructions 154. For example, based on the disposition instruction 154(A), the communication platform 104(A) may be caused to permanently delete one or more individual data files contained within the message data 126(A), apply a superseding label to one or more other individual data files contained within the message data 126(A), or any other suitable retention action (whether expressly described herein or not).

In some implementations, the disposition manager 148 may be a human review that manually examines file property data associated with individual data files and, based thereon, determines which retention actions should be performed with respect to these individual data files. Then, the human disposition manager 148 may manually (e.g., via a user interface component such as a mouse, keyboard, microphone, etc.) generate input data 140. In some implementations, the disposition manager 148 may be a “bot” (e.g., a software application that runs automated tasks) that examines file property data and, ultimately, generates input data 140 based thereon. An exemplary bot may deploy machine learning techniques to examine actions of a human disposition reviewer and, over time, learn how to treat data files that have reached their disposition review age based on file property data thereof.

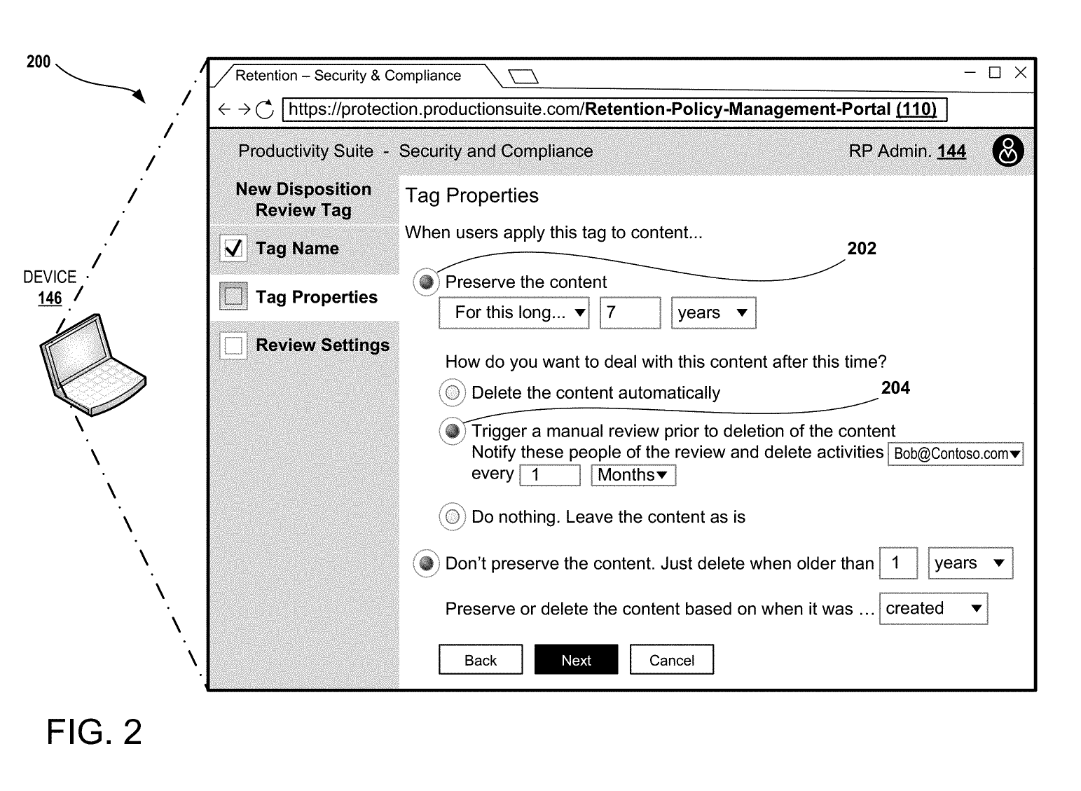

Turning now to FIG. 2, aspects are illustrated of a user interface (UI) 200 corresponding to the retention policy management portal (RPMP) 110 that can be displayed on the retention policy administrator device 146 to enable the retention policy administrator 144 to define the retention parameters 125 corresponding to the file management label described in relation to FIG. 1. In the illustrated scenario, the retention policy administrator 144 is defining retention parameters 125 that associate a file retention age of seven years with the file management label. In particular, the retention policy administrator 144 has selected a “Preserve the content” user interface element (UIE) 202 and has specified a value of seven years for this UIE. Accordingly, individual data files that are tagged with the file management label will be forcibly retained by the RPEE 108 and/or individual productivity platforms 104 at least until the individual data files reach seven years of age (e.g., as measured from a date that the individual data files were created, last modified, tagged the file management label, etc.).

As further illustrated, the retention parameters 125 further cause permanent deletion of individual data files that are tagged the file management label. In some configurations, the deletion of the files can be contingent upon receiving one or more disposition confirmations in association with the individual data files. In particular, the retention policy administrator 144 has selected a “Trigger Manual Review” UIE 204 and has defined a notification interval (e.g., 1 month) and a disposition manager 148 (e.g., Bob@Contoso.com) for association with the file management label. Accordingly, in the illustrated scenario, the system 100 will prevent permanent deletion of an individual data file that has been tagged with the file management label at least until a disposition confirmation has been received in association with the individual data file (e.g., the disposition manager 148 has generated input data 140 confirming that permanent deletion of the individual data files is appropriate) and the individual data file has also reached at least seven years of age.

Turning now to FIG. 3A, aspects are illustrated of a UI 300 corresponding to the CPMR portal 136 that can be displayed on the disposition manager device 106 to communicate aspects of the upcoming disposition report 138 that indicates one or more individual data files that have reached the disposition review age. In the illustrated scenario, the data files identified within the upcoming disposition report 138 correspond to at least two different productivity platforms. In particular, the upcoming disposition report 138 includes at least three individual email files that are stored in association with a mailbox of a particular user (e.g., John Doe) that is provided by the communication platform 104(A) and at least one individual portable document format (PDF) file that is stored in association with a cloud-based storage account of another particular user (e.g., Jane Doe) that is provided by the file hosting platform 104(B).

In some examples, the CPMR portal 136 enables the disposition manager 148 to set the disposition review age by defining an expiration window for the upcoming-dispositions report 138. For example, in the illustrated scenario the disposition manager 148 has defined an expiration window ranging from Jun. 15, 2017 through Jul. 15, 2017 to cause the CPMR portal 136 to indicate data files that are set to expire within this expiration window. In various examples, the disposition manager 148 may define an expiration window that is at least partially in the future (e.g., at least some dates within the expiration window have not passed) to view file properties of data files that have not yet expired (e.g., have yet to reach a file retention age). For example, in the illustrated scenario, the upcoming disposition report 138 displayed by the CPMR portal 136 has been generated on Jun. 13, 2017 which is two days prior to the beginning of the evaluation window. Accordingly, the disposition manager may review and, ultimately, generate disposition confirmation instructions in association with individual data files that have yet to reach a corresponding file retention age. In some implementations, the system 100 may transmit disposition instructions 154 in association with the individual data files prior to their expiry date, e.g., a date the individual files reach their file retention age. In such implementations, these individual data files may be automatically disposed of by their corresponding productivity platforms when they reach their file retention age without further input and/or review by the disposition manager 148.

In some examples, UI 300 may include a “filter” user interface element (UIE) 302 to enable the disposition manager 148 to define one or more parameters in which to filter the upcoming disposition report 138. For example, the disposition manager 148 may define parameters to filter the results of the upcoming disposition report (which although illustrated as including only four individual data files could in many circumstances include tens, hundreds, and/or thousands of individual data files) to cause the CPMR portal 136 to display only a subset of the results that match the filter parameters. As a more specific but nonlimiting example, the disposition manager 148 may cause the CPMR portal 136 to filter the results to show only data files that correspond to a specific user, data files that correspond to a specific productivity platform, data files that include one or more specific keywords, data files that have been automatically tagged by the system and/or a file labeling engine thereof, data files that have been manually tagged by the information worker 150, data files that expire on a specific date and/or range of dates, data files that were tagged on a specific date and/or range of dates, or any other suitable parameter to filter the results of the upcoming disposition report 138.

In some examples, the UI may include an “refresh” UIE 304 to enable the disposition manager 148 to instruct the retention policy management service 102 to update (e.g., refresh) the upcoming disposition report 138 in light of user defined parameters. For example, one or more parameters defined by the user may be associated with one or more results that have not been returned within a current version of the upcoming disposition report 138. Accordingly, the “refresh” UIE 304 may enable the disposition manager 148 to instruct the retention policy management service 102 to reanalyze the productivity data 126 to identify one or more results that have not already been returned to the disposition manager device 106 within a current version of the upcoming disposition report 138.

Turning now to FIG. 3B, aspects are illustrated of a UI 320 that correspond to the CPMR portal 136 and that include UIEs 322 that enable the disposition manager 148 to generate input data 140 that defines one or more retention actions to be performed with respect to one or more of the individual data files identified within the upcoming disposition report 138 and selected by the disposition manager 148. In the illustrated scenario, the UI 320 includes four UIEs 322 that enable the disposition manager 148 to assign the individual data files with a different classification label (also referred to as a file management label), to extend the file retention age associated with the individual data files, to create a permanent archive copy of one or more of the individual data files, and/or to permanently delete the individual data files from one or more storage devices associated with the productivity platforms 104. Here, the disposition manager 148 has selected a “Delete Permanently” UIE 322 to generate input data 140 that causes a disposition confirmation to be transmitted to the communication platform 104(A) and, ultimately, causes the communication platform 104(A) to permanently delete the file content data corresponding to the selected data file.

As described elsewhere herein, in various examples, the system 100 may prevent individual productivity platforms 104 from deleting individual data files until a corresponding disposition confirmation is received, even after the individual data files reach their file retention age. For example, suppose that a particular data file has been tagged with a file management label described in relation to FIG. 2. That is, a file management label that defines a retention age of seven years and further requires a disposition confirmation prior to permanent deletion of the underlying file content. Under these circumstances, even if the particular data file has surpassed seven years of age, the system 100 may forcibly retain the particular data file (e.g., prevent individual productivity platforms from deleting the particular data file) until the disposition manager 148 confirms via the UIE 322 that the underlying file content of the particular data file should be permanently deleted.

Turning now to FIG. 3C, aspects are illustrated of a UI 340 that corresponds to the CPMR portal 136 and that includes UIEs 342 that enable the disposition manager 148 to select one or more bulk retention actions to be performed in association with a plurality of selected data files. The UI 340 is similar to the UI 320 with the exception that the UIEs 342 of the UI 340 are configured to enable the disposition manager to indicate bulk retention actions to simultaneously prescribe a particular retention action to a plurality of individual data files. In the illustrated scenario, the disposition manager 148 has selected all four of the individual data files that correspond to the upcoming disposition report 138 and has further selected a “Delete Permanently” UIE 342 to generate input data 140 that causes a disposition confirmation to be transmitted to each of the communication platform 104(A) and the file hosting platform 104 (B).

In some examples, the UI 340 may include a “select all” UIE 344 to enable the disposition manager 148 to instruct the CPMR portal 136 to select all of the results that correspond to a currently displayed version of the upcoming disposition report 138 and any parameters that the disposition manager 148 has defined to filter the results of the upcoming disposition report 138. For example, the disposition manager may enter parameters to cause the CPMR portal 136 to filter the results to show only data files that are owned by one or more specific information workers and that are further scheduled to expire within a particular evaluation window. Then, after the CPMR portal 136 filters the results, the disposition manager 148 may activate the “select all” UIE 344 to select all of the currently displayed results. It can be appreciated that such a “select all” UIE 344 may be beneficial in the event that the disposition manager 148 wishes to perform bulk retention actions against subsets of data files that have specific attributes.

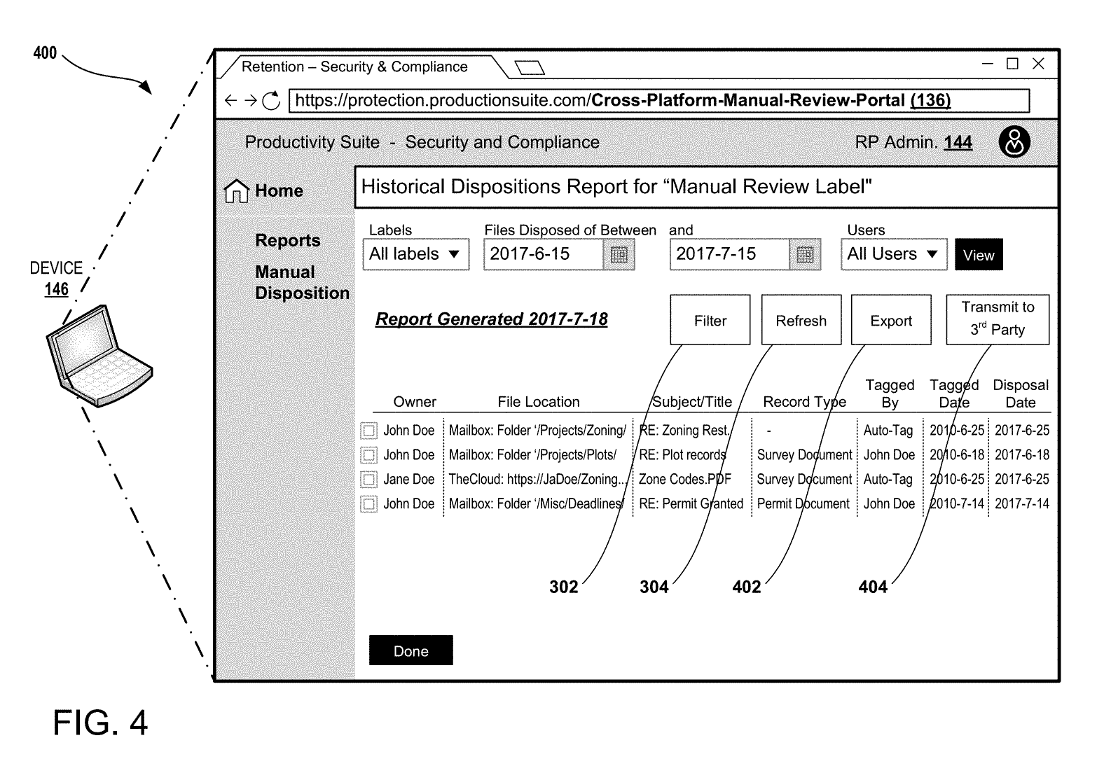

Turning now to FIG. 4, aspects are illustrated of a UI 400 corresponding to the CPMR portal 136 that can be displayed to communicate aspects of the historical dispositions report 142 that indicates file property data of individual data files that have been purged from storage corresponding to one or more productivity platforms 104. Stated alternatively, the historical disposition report 142 includes file property data corresponding to individual data files for which the underlying file content data has been permanently deleted based on disposition confirmations being received and corresponding file retention ages having been reached. Upon the underlying file content data of a particular data file being permanently deleted (e.g., “purged”) from storage corresponding to a productivity platform(s), the system may retain at least some of the file property data corresponding to the particular file. The file property data included within the historical disposition report may include any of the file property data discussed with respect to the upcoming disposition report. Additionally or alternatively, the file property data included within the historical disposition report may further indicate a disposal date corresponding to particular data files (e.g., a date at which the underlying file content of the particular data file was permanently deleted.) In the illustrated scenario, the historical disposition report 142 indicates that a particular data file that was previously stored in association with a mailbox of “John Doe” and which is entitled “RE: Zoning Rest.” was permanently deleted from storage of the communication platform 104(A) on Jun. 25, 2017.

In some examples, the UI 400 may include an “Export” UIE 402 to enable the disposition manager 148 to export a digital copy of the historical dispositions report 142 to the disposition manager device 106. For example, the historical dispositions report 142 may be converted into a suitable file format such as, for example, portable document format (PDF) and downloaded to the disposition manager device 106. Accordingly, the disposition manager 148 may then be able to reliably present to and/or exchange the historical disposition report 142 with one or more other users and/or entities independent of software, hardware, or operating system.

In some examples, the UI 400 may include a “Transmit to 3rd Party” UIE 404 to enable the disposition manager 148 to transmit a digital copy of the historical dispositions report 142 to a third-party for a variety of reasons such as, for example, to demonstrate adherence to the URP 112 and/or government mandated retention policies. For example, an organization may transmit the historical disposition report 142 to a governmental agency as evidence that the organization has regularly retained particular classes of data files (e.g., tax related documents) for at least a legally prescribed minimum time period. Upon selection of the “Transmit to 3rd Party” UIE 404, the disposition manager 148 may be prompted to provide recipient information associated with a particular third party that the disposition manager 148 intends to transmit the historical disposition report 142 to. For example, the disposition manager 148 may provide a fax number and/or email address associated with the intended third-party recipient.

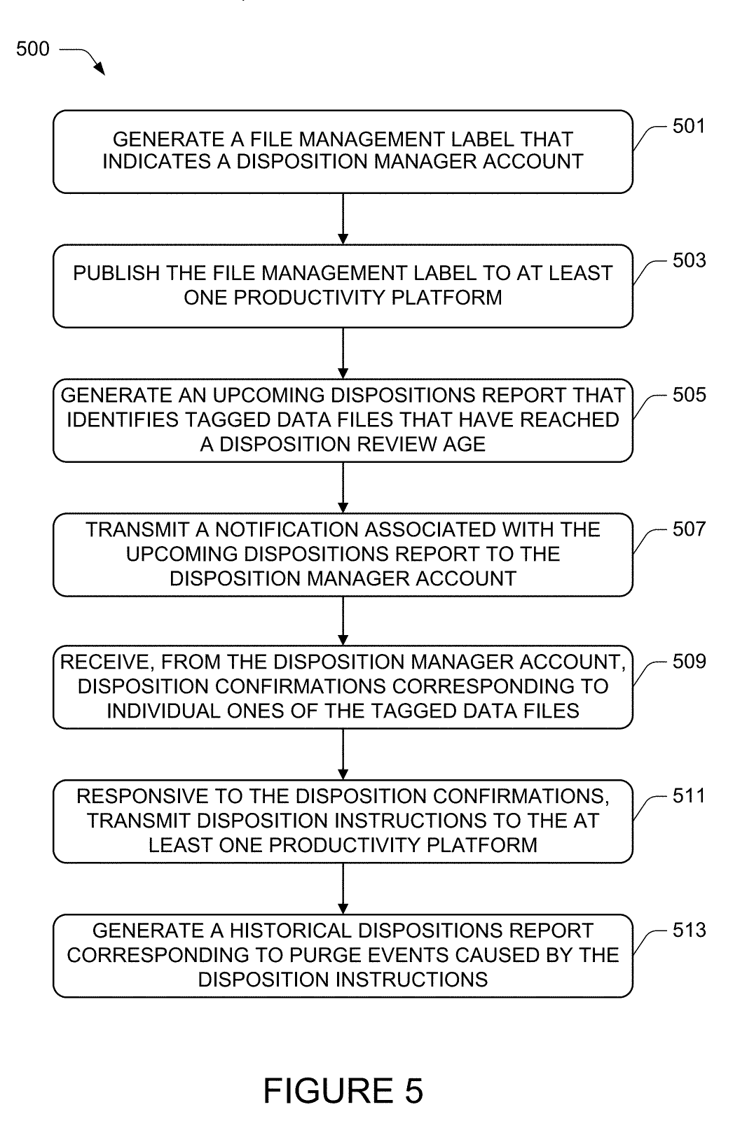

FIG. 5 is a flow diagram of an illustrative process 500 to generate data retention reports (e.g., upcoming disposition reports and/or historical disposition reports) associated with disposition of data files that are tagged with a file management label. The process 500 is described with reference to FIGS. 1A-4. The process 500 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform or implement particular functions. The order in which operations are described is not intended to be construed as a limitation, and any number of the described blocks can be combined in any order and/or in parallel to implement the process. Other processes described throughout this disclosure shall be interpreted accordingly.

At block 501, a system 100 may generate a file management label that indicates at least one disposition manager account. In various instances, the file management label may be generated based on retention parameters 125 that are defined by a retention policy administrator 144. For example, a retention policy administrator 144 may log into a retention policy administrator account by providing user credentials that are assigned by an organization to the retention policy administrator 144. In some implementations, the file management label may be associated with a retention policy that corresponds to a single productivity platform. For example, the file management label may be published to only the communication platform 104(A) or only to the file hosting platform 104(B), but not both. In other implementations, the file management label may be associated with a unified retention policy that corresponds to multiple productivity platforms. It is worth noting that as used herein, the term “retention policy” differs from the term “unified retention policy” in the sense that a retention policy is not necessarily configured to be deployed across multiple productivity platforms. Accordingly, it can be appreciated that a “unified retention policy” is also a “retention policy,” whereas a “retention policy” is not necessarily a “unified retention policy.” Stated alternatively, unified retention policies can be considered a class or type of retention policy.

In various instances, the file management label may also define a retention age threshold such that individual files that are tagged with the file management label are forcibly retained by the system 100 at least until the files reach or exceed the retention age threshold. In some implementations, the file management label may also be configured to inform the system 100 and/or individual productivity platforms 104 that permanent deletion of individual data files is contingent upon receiving a disposition confirmation in association with the individual data files. Stated alternatively, receiving an express confirmation that purging file content data corresponding to a particular data file is appropriate may be a prerequisite to purging the file content data from one or more storage devices. Accordingly, it can be appreciated that in various implementations permanent deletion of file content data for a particular data file may be contingent upon both receiving a disposition confirmation for the particular data file and also the particular data file reaching or exceeding the file retention age associated with the file management label.

At block 503, the system 100 may publish the file management label to at least one productivity platform 104 to enable individual data files corresponding to the at least one productivity platform 104 to be tagged with the file management label. In some instances, individual data files may be manually tagged with the file management label by an information worker 150. For example, upon receiving an email file within the inbox 128, the information worker 150 may “right-click” on the email file to cause the user device 152 to expose a UIE that enables the file management label to be associated with (e.g., “tagged” onto) the file. In some instances, individual data files may be automatically tagged with the file management label by a file labeling engine associated with one or both of the retention policy management service 102 and/or an individual platform 104. For example, the file management label may be associated with one or more data retention rules 114 that define various file attributes that can trigger the file labeling engine to tag an individual data file with the file management label.

At block 505, the system 100 may generate an upcoming disposition report that identifies a plurality of data files, within the productivity data 126, and that have both been tagged with the file management label and have reached a disposition review age. In some implementations, the disposition review age is different than a file retention age corresponding to the individual data files. For example, a particular data file may have a file retention age that is set to seven years such that the system forcibly retains the particular data file for a seven-year period. Additionally, the particular file may have a disposition review age that is defined by measuring a predetermined amount of time from the file retention age. For example, a predetermined amount of time may be one month such that the disposition review age for any particular file that is tagged with the file management label is defined as being one month prior to that particular file's file retention age. In some implementations, the disposition review age may be the same as a file retention age. For example, review of the particular data file is only triggered once it has reached its file retention age.

In some implementations, the system 100 may be configured to determine geolocation data associated with individual data files and then prescribe a specific disposition review age, file management label, and/or file retention age to the individual files based on a specific geolocation that they are associated with. For example, a single organization may include different offices that reside in different territories (e.g., countries, states, unions of states and/or countries, etc.). Accordingly, various data files that are similar in terms of content and/or properties may be subject to varying retention policies. For example, the different offices of the single organization may be subject to different governmental regulations (e.g., a first country may require tax related documents to be retained for at least seven years whereas another country may allow the same documents to be deleted after only three years).

At block 507, the system 100 may transmit a notification associated with the upcoming disposition report to the disposition manager account. For example, the retention policy management service 102 may be configured to transmit an email notification to the email account of the disposition manager 148. In various implementations, the notification may include varying degrees of detail regarding the upcoming disposition report. For example, in a first scenario the notification may simply inform the disposition manager that the upcoming disposition report has been generated and is available via the CPMR portal 136. In another scenario, the notification may include summarized details associated with the upcoming disposition report. For example, the notification may indicate to the disposition manager a number of data files that are scheduled to expire within a particular range of dates, e.g., an expiration window. In yet another example, the notification may include a full copy of the upcoming disposition report.

In some examples, the system 100 may transmit a plurality of notifications to the disposition manager account based on a notification interval. For example, the system may be configured to transmit a notification to the disposition manager account every one week, every one month, or any other suitable amount of time. As another example, the system may be configured to transmit a notification to the disposition manager account once a threshold number of individual data files have reached their disposition review ages. For example, a new notification may be transmitted whenever ten data files reach their disposition review ages, one-hundred data files reach their disposition review ages, or any other suitable threshold number.

At block 509, the system 100 may receive input data from the disposition manager account where the input data includes at least some disposition confirmations corresponding to individual ones of the data files identified within the upcoming disposition report. For example, as described with relation to FIGS. 3B and 3C, the disposition manager may interact with one or more UIEs that are displayed within the CPMR portal 136 to identify one or more individual data files that are to be permanently deleted from storage that is allocated to the productivity platforms 104.

At block 511, the system 100 may react to the disposition confirmations received from the disposition manager account within the input data 140 by transmitting disposition instructions to the at least one productivity platform. In some examples, the disposition instructions may cause the at least one productivity platform to completely purge file content data corresponding to the data files for which disposition confirmations have been received. Accordingly, upon receiving the disposition instructions, the at least one productivity platform may perform one or more purge events to permanently remove the corresponding file content data from one or more physical storage devices associated with the at least one productivity platform.

At block 513, the system 100 may generate a historical disposition report that serves as a record of the one or more purge events performed by the at least one productivity platform. For example, as described in relation to FIG. 4, a historical disposition report may indicate a plurality of data files that once existed within storage associated with the at least one productivity platform but for which the underlying file content (e.g., the file content data) has been permanently deleted. In some implementations, the historical disposition report may indicate various file properties associated with individual data files that have been permanently deleted.

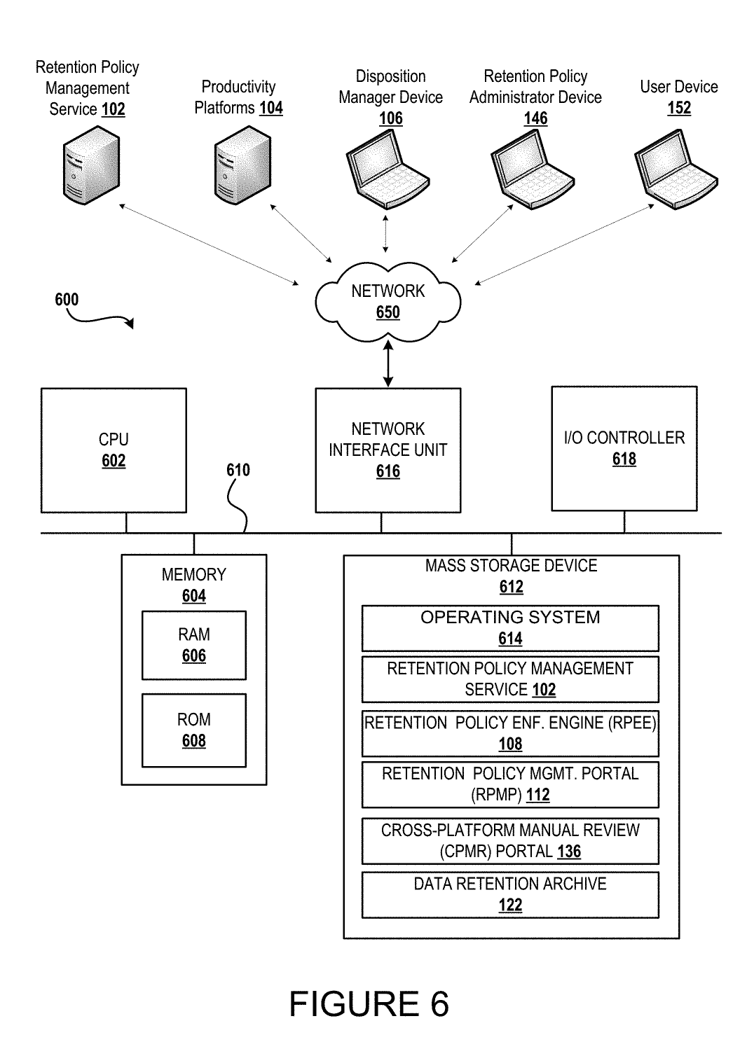

FIG. 6 shows additional details of an example computer architecture 600 for a computer capable of executing the retention policy management service 102, cross-platform manual review (CPMR) portal 136, the communication platform 104(A), the file hosting platform 104(B), the other productivity platform 104(N), and/or any program components thereof as described herein. Thus, the computer architecture 600 illustrated in FIG. 6 illustrates an architecture for a server computer, or network of server computers, or any other types of computing devices suitable for implementing the functionality described herein. The computer architecture 600 may be utilized to execute any aspects of the software components presented herein.

The computer architecture 600 illustrated in FIG. 6 includes a central processing unit 602 (“CPU”), a system memory 604, including a random-access memory 606 (“RAM”) and a read-only memory (“ROM”) 608, and a system bus 610 that couples the memory 604 to the CPU 602. A basic input/output system containing the basic routines that help to transfer information between elements within the computer architecture 600, such as during startup, is stored in the ROM 608. The computer architecture 600 further includes a mass storage device 612 for storing an operating system 614, other data, and one or more application programs. The mass storage device 612 may further include one or more of the retention policy management service 102, the retention policy enforcement engine (RPEE) 108, the retention policy management portal (RPMP) 112, cross-platform manual review (CPMR) portal 136, and/or the data retention archive 122.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the computer architecture 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes of the claims, the phrase “computer storage medium,” “computer-readable storage medium” and variations thereof, does not include waves, signals, and/or other transitory and/or intangible communication media, per se.

According to various techniques, the computer architecture 600 may operate in a networked environment using logical connections to remote computers through a network 650 and/or another network (not shown). The computer architecture 600 may connect to the network 650 through a network interface unit 616 connected to the bus 610. It should be appreciated that the network interface unit 616 also may be utilized to connect to other types of networks and remote computer systems. The computer architecture 600 also may include an input/output controller 618 for receiving and processing input from a number of other devices, including a keyboard, mouse, or electronic stylus (not shown in FIG. 6). Similarly, the input/output controller 618 may provide output to a display screen, a printer, or other type of output device (also not shown in FIG. 6). It should also be appreciated that via a connection to the network 650 through a network interface unit 616, the computing architecture may enable the retention policy management service 102 to communicate with one or more of the productivity platforms 104, the disposition manager device 106, the retention policy administrator device 146, and/or the user device 152.

It should be appreciated that the software components described herein may, when loaded into the CPU 602 and executed, transform the CPU 602 and the overall computer architecture 600 from a general-purpose computing system into a special-purpose computing system customized to facilitate the functionality presented herein. The CPU 602 may be constructed from any number of transistors or other discrete circuit elements, which may individually or collectively assume any number of states. More specifically, the CPU 602 may operate as a finite-state machine, in response to executable instructions contained within the software modules disclosed herein. These computer-executable instructions may transform the CPU 602 by specifying how the CPU 602 transitions between states, thereby transforming the transistors or other discrete hardware elements constituting the CPU 602.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 may include other types of computing devices, including hand-held computers, embedded computer systems, personal digital assistants, and other types of computing devices known to those skilled in the art. It is also contemplated that the computer architecture 600 may not include all of the components shown in FIG. 6, may include other components that are not explicitly shown in FIG. 6, or may utilize an architecture completely different than that shown in FIG. 6.

### EXAMPLE CLAUSES

The disclosure presented herein may be considered in view of the following clauses.

Example Clause A, a computer-implemented method, comprising: generating a file management label based on retention parameters that define a file retention age and a disposition manager account; communicating the file management label to a plurality of productivity platforms that include at least a first productivity platform and a second productivity platform; selecting a plurality of data files to be tagged with the file management label, wherein the plurality of data files have reached a disposition review age that exceeds the file retention age; generating an upcoming-disposition report that identifies the plurality of data files, wherein the plurality of data files includes at least a first data file that corresponds to the first productivity platform and a second data file that corresponds to the second productivity platform; based on the upcoming-disposition report, causing a computing device to display a cross-platform manual review portal that indicates file properties of individual data files of the plurality of data files and includes at least one user interface element that is configured to enable a user associated with the disposition manager account to generate input data that indicates at least one of: one or more disposition confirmations for the individual data files, an extended disposition review age for the individual data files, or a superseding label for reclassification of the individual data files; and causing, based on the input data, the first productivity platform to execute a first disposition instruction corresponding to the first data file and the second productivity platform to execute a second disposition instruction corresponding to the second data file.

Example Clause B, the computer-implemented method of Example Clause A, further comprising generating, based on the input data, a historical disposition report associated with a plurality of file purge events, wherein the historical disposition report indicates file property data corresponding to individual file purge events of the plurality of file purge events.

Example Clause C, the computer-implemented method of any one of Example Clauses A through B, wherein the file management label is associated with access permissions that permit the disposition manager account to access file property data corresponding to the individual data files based on the individual data files being tagged with the file management label.

Example Clause D, the computer-implemented method of Example Clause C, wherein the access permissions restrict the disposition manager account from accessing file content data corresponding to the individual data files.

Example Clause E, the computer-implemented method of any one of Example Clauses A through D, comprising preventing the individual data files from being deleted from at least one storage device at least until the disposition confirmations are received in association with the individual data files.

Example Clause F, the computer-implemented method of any one of Example Clauses A through E, wherein the at least one user interface element is further configured to enable the user to input filter parameters to associate at least an expiration window with the file management label, and wherein the cross-platform manual review portal is further configured to display aspects of the upcoming-disposition report to indicate at least some data files that are scheduled to expire during the expiration window.

Example Clause G, the computer-implemented method of any one of Example Clauses A through F, wherein the expiration window defines the disposition review age as being prior to the file retention age, the file retention age defining an earliest age at which the individual data files are deleted from at least one storage device if corresponding disposition confirmations are received in association with the individual data files.

Example Clause H, the computer-implemented method of any one of Example Clauses A through G, further comprising: determining geolocation data indicating that the first plurality of data files corresponds to a first geolocation and that a second plurality of files, that are tagged with the file management label, correspond to a second geolocation; prescribing, based on the geolocation data, the disposition review age to the first plurality of data files and a second disposition review age to the second plurality of data files.

While Example Clauses A through H are described above with respect to a method, it is understood in the context of this document that the subject matter of Example Clauses A through H can also be implemented by a device, by a system, and/or via computer-readable storage media.

Example Clause I, a system comprising: at least one processor; and at least one memory in communication with the at least one processor, the at least one memory having computer-readable instructions stored thereupon that, when executed by the at least one processor, cause the at least one processor to: generate a file management label that indicates at least one disposition manager to perform a manual review of data files that reach a disposition review age; publish the file management label to at least one productivity platform to enable a plurality of data files to be tagged with the file management label; generate an upcoming-disposition report that identifies a subset of data files, of the plurality of data files, that have reached the disposition review age; transmit a notification associated with the upcoming-dispositions report to prompt the at least one disposition manager to generate disposition confirmations corresponding to individual data files of the subset of data files; and in response to the disposition confirmations, transmit disposition instructions to the at least one productivity platform, wherein the disposition instructions cause the at least one productivity platform to perform a plurality of file purge events to delete the individual data files from at least one storage device.

Example Clause J, the system of Example Clause I, wherein the computer-readable instructions further cause the at least one processor to generate, based on the plurality of file purge events, a historical disposition report that indicates file property data corresponding to individual file purge events of the plurality of file purge events.

Example Clause K, the system of any one of Example Clauses I through J, determine a notification interval corresponding to the manual review of data files that reach the disposition review age; based on the notification interval passing from a transmission time of the notification, transmit a second notification associated with a second upcoming-disposition report to prompt the at least one disposition manager to generate other disposition confirmations corresponding to other individual data files that have reached the disposition review age.

Example Clause L, the system of any one of Example Clauses I through K, wherein at least some of the disposition confirmations are generated prior to a file retention age defining a time period during which the individual data files are prevented from being deleted from the at least one storage device.

Example Clause M, the system of any one of Example Clauses I through L, wherein the computer-readable instructions further cause the at least one processor to: expose a manual review portal to enable the disposition manager to generate an archive instruction in association with a particular data file of the subset of data files; in response to the archive instruction, reclassifying the particular data file to prevent the particular data file from being deleted from the at least one storage device.

Example Clause N, the system of any one of Example Clauses I through M, wherein the file management label provisions the at least one disposition manager with access permissions that: permit access to file property data corresponding to the individual data files, and restrict access to file content data corresponding to the individual data files.

Example Clause O, the system of Example Clause N, the file management label further provisions a content creator with second access permissions that permit tagging of the individual data files with the file management label through a user account of the at least one productivity platform.

While Example Clauses I through O are described above with respect to a system, it is understood in the context of this document that the subject matter of Example Clauses I through O can also be implemented by a device, via a computer-implemented method, and/or via computer-readable storage media.

Example Clause P, a computer-implemented method, comprising: publishing, to at least one productivity platform, a file management label that indicates a disposition manager and a disposition review age; generating an upcoming-disposition report that identifies a plurality of data files, corresponding to the at least one productivity platform, that are tagged with the file management label and that have reached the disposition review age; transmitting a notification associated with the upcoming-disposition report to prompt the disposition manager to generate disposition confirmations corresponding to individual data files of the plurality of data files; causing, in response to the disposition confirmations, the at least one productivity platform to perform a plurality of file purge events to delete the individual data files from at least one storage device; and generating, based on the plurality of file purge events, a historical dispositions report that indicates file property data corresponding to individual file purge events of the plurality of file purge events.

Example Clause Q, the computer-implemented method of Example Clause P, wherein the file management label provisions first access permissions to enable a content creator to tag the individual data files with the file management label and second access permissions to enable the disposition manager to cause the plurality of file purge events to occur when the individual data files reach a file retention age.

Example Clause R, the computer-implemented method of any one of Example Clauses P through Q, wherein at least some of the disposition confirmations are received prior to at least some of the individual data files reaching a file retention age.

Example Clause S, the computer-implemented method of any one of Example Clauses P through R, further comprising measuring a predetermined time period from a file retention age that is defined by the file management label to determine the disposition review age.

Example Clause T, the computer-implemented method of any one of Example Clauses P through S, comprising transmitting an instance of the historical dispositions report to a regulatory agency in response to input data that indicates the regulatory agency.

While Example Clauses P through T are described above with respect to a method, it is understood in the context of this document that the subject matter of Example Clauses P through T can also be implemented by a device, by a system, and/or via computer-readable storage media.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A computer-implemented method, comprising:
generating a file management label based on retention parameters that define a file retention age and a disposition manager account;
communicating the file management label to a plurality of productivity platforms that include at least a first productivity platform and a second productivity platform;
selecting a plurality of data files to be tagged with the file management label, wherein the plurality of data files have reached a disposition review age that exceeds the file retention age;
generating an upcoming-disposition report that identifies the plurality of data files, wherein the plurality of data files includes at least a first data file that corresponds to the first productivity platform and a second data file that corresponds to the second productivity platform;
based on the upcoming-disposition report, causing a computing device to display a cross-platform manual review portal that indicates file properties of individual data files of the plurality of data files and includes at least one user interface element that is configured to enable a user associated with the disposition manager account to generate input data that indicates at least one of:
one or more disposition confirmations for the individual data files,
an extended disposition review age for the individual data files, or
a superseding label for reclassification of the individual data files; and
causing, based on the input data, the first productivity platform to execute a first disposition instruction corresponding to the first data file and the second productivity platform to execute a second disposition instruction corresponding to the second data file.

2. The computer-implemented method of claim 1, further comprising generating, based on the input data, a historical disposition report associated with a plurality of file purge events, wherein the historical disposition report indicates file property data corresponding to individual file purge events of the plurality of file purge events.

3. The computer-implemented method of claim 1, wherein the file management label is associated with access permissions that permit the disposition manager account to access file property data corresponding to the individual data files based on the individual data files being tagged with the file management label.

4. The computer-implemented method of claim 3, wherein the access permissions restrict the disposition manager account from accessing file content data corresponding to the individual data files.

5. The computer-implemented method of claim 1, comprising preventing the individual data files from being deleted from at least one storage device at least until the disposition confirmations are received in association with the individual data files.

6. The computer-implemented method of claim 1, wherein the at least one user interface element is further configured to enable the user to input filter parameters to associate at least an expiration window with the file management label, and wherein the cross-platform manual review portal is further configured to display aspects of the upcoming-disposition report to indicate at least some data files that are scheduled to expire during the expiration window.

7. The computer-implemented method of claim 6, wherein the expiration window defines the disposition review age as being prior to the file retention age, the file retention age defining an earliest age at which the individual data files are deleted from at least one storage device if corresponding disposition confirmations are received in association with the individual data files.

8. The computer-implemented method of claim 1, further comprising:
determining geolocation data indicating that the first plurality of data files corresponds to a first geolocation and that a second plurality of files, that are tagged with the file management label, correspond to a second geolocation;
prescribing, based on the geolocation data, the disposition review age to the first plurality of data files and a second disposition review age to the second plurality of data files.

9. A system, comprising:
at least one processor; and
at least one memory in communication with the at least one processor, the at least one memory having computer-readable instructions stored thereupon that, when executed by the at least one processor, cause the at least one processor to:
generate a file management label that indicates at least one disposition manager to perform a manual review of data files that reach a disposition review age;
publish the file management label to at least one productivity platform to enable a plurality of data files to be tagged with the file management label;
generate an upcoming-disposition report that identifies a subset of data files, of the plurality of data files, that have reached the disposition review age;
transmit a notification associated with the upcoming-dispositions report to prompt the at least one disposition manager to generate disposition confirmations corresponding to individual data files of the subset of data files; and
in response to the disposition confirmations, transmit disposition instructions to the at least one productivity platform, wherein the disposition instructions cause the at least one productivity platform to perform a plurality of file purge events to delete the individual data files from at least one storage device.

10. The system of claim 9, wherein the computer-readable instructions further cause the at least one processor to generate, based on the plurality of file purge events, a historical disposition report that indicates file property data corresponding to individual file purge events of the plurality of file purge events.

11. The system of claim 9, wherein the computer-readable instructions further cause the at least one processor to:
determine a notification interval corresponding to the manual review of data files that reach the disposition review age;
based on the notification interval passing from a transmission time of the notification, transmit a second notification associated with a second upcoming-disposition report to prompt the at least one disposition manager to generate other disposition confirmations corresponding to other individual data files that have reached the disposition review age.

12. The system of claim 9, wherein at least some of the disposition confirmations are generated prior to a file retention age defining a time period during which the individual data files are prevented from being deleted from the at least one storage device.

13. The system of claim 9, wherein the computer-readable instructions further cause the at least one processor to:
expose a manual review portal to enable the disposition manager to generate an archive instruction in association with a particular data file of the subset of data files;
in response to the archive instruction, reclassifying the particular data file to prevent the particular data file from being deleted from the at least one storage device.

14. The system of claim 9, wherein the file management label provisions the at least one disposition manager with access permissions that: permit access to file property data corresponding to the individual data files, and restrict access to file content data corresponding to the individual data files.

15. The system of claim 14, wherein the file management label further provisions a content creator with second access permissions that permit tagging of the individual data files with the file management label through a user account of the at least one productivity platform.

16. A computer-implemented method, comprising:
publishing, to at least one productivity platform, a file management label that indicates a disposition manager and a disposition review age;
generating an upcoming-disposition report that identifies a plurality of data files, corresponding to the at least one productivity platform, that are tagged with the file management label and that have reached the disposition review age;
transmitting a notification associated with the upcoming-disposition report to prompt the disposition manager to generate disposition confirmations corresponding to individual data files of the plurality of data files;
causing, in response to the disposition confirmations, the at least one productivity platform to perform a plurality of file purge events to delete the individual data files from at least one storage device; and
generating, based on the plurality of file purge events, a historical dispositions report that indicates file property data corresponding to individual file purge events of the plurality of file purge events.

17. The computer-implemented method of claim 16, wherein the file management label provisions first access permissions to enable a content creator to tag the individual data files with the file management label and second access permissions to enable the disposition manager to cause the plurality of file purge events to occur when the individual data files reach a file retention age.

18. The computer-implemented method of claim 16, wherein at least some of the disposition confirmations are received prior to at least some of the individual data files reaching a file retention age.

19. The computer-implemented method of claim 16, further comprising measuring a predetermined time period from a file retention age that is defined by the file management label to determine the disposition review age.

20. The computer-implemented method of claim 16, comprising transmitting an instance of the historical dispositions report to a regulatory agency in response to input data that indicates the regulatory agency.
